(19) United States
(12) Patent Application Publication
(10) Pub. No.: US 2015/0325180 A1
(43) Pub. Date: Nov. 12, 2015

(54) Fast Symmetric Drive Pixel Circuits And Methods

(71) Applicant: Pixtronix, Inc., San Diego, CA (US)

(72) Inventor: Andradige Nalin Silva, Canton, MA (US)

(73) Assignee: PIXTRONIX, INC., San Diego, CA (US)

(21) Appl. No.: 14/132,764

(22) Filed: Dec. 18, 2013

(51) Int. Cl. G09G 3/34

(52) U.S. Cl. CPC G09G 3/3433; G09G 2310/0251; G09G 2300/06; G09G 2300/0473; G09G 2300/08

(57) ABSTRACT

This disclosure provides systems, methods and apparatus for addressing an array of pixels in a display. In one aspect, an electromechanical device includes an array of pixels and control circuitry including, for each pixel in the array of pixels, a first switch coupled to a first node for discharging an accumulated charge across the first node, a second switch coupled to a second node for discharging an accumulated charge across the second node, and a third switch coupled to the first switch, the second switch and a third node, the third switch capable of discharging an accumulated charge across the third node. In certain implementations, a method for addressing an array of pixels in a display is provided including charging a first and second node to an actuate voltage, charging a third node to a V_{mid} voltage, and moving a light modulator to a first position.

### TECHNICAL FIELD

This disclosure relates to the field of displays, and particularly to circuits for controlling displays with movable electromechanical system elements, and methods for operating the same.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers.

Dual-actuated MEMS shutter displays, displays having two actuators to move a shutter, are known in the art. The dual-actuated MEMS shutter display is coupled between a first node and a second node. Actuation of these known dual-actuated MEMS shutter displays requires charging both first and second actuators coupled to the first node and second node respectively, and discharging one of the first and second actuators to move the MEMS shutter. For example, to move a dual-actuated shutter both of the first and second nodes are charged to an actuation voltage high enough to move the shutter. Then, one of the first and second nodes is discharged to move the shutter to its intended position. During operation, charge injection, whereby electric charge leaks through a circuit element (e.g., a transistor), may occur thus dragging down the voltage on the first node and preventing the MEMS shutter from actuating correctly. The charge injection may also result in wasted power during operation of the control circuitry. In addition, simultaneous discharge of voltage from the first and second nodes in dual-actuated MEMS shutter displays can result in incorrect actuation of the MEMS light modulator. Furthermore, extra time is required to discharge the entire voltage across the first and/or second node prior to moving the shutter in a dual-actuated MEMS display, thereby resulting in slower display operation times.

It would be beneficial to have a system and method for actuating a dual-actuated MEMS light modulator while preventing charge injection across the first node, and for preventing simultaneous discharge of the first and second nodes. It would also be beneficial to have a system and method for saving power during control of an array of light modulators, and for increasing the global update speed of the light modulators in the array of light modulators in a display.

### SUMMARY

The systems, methods and devices of this disclosure each have several innovative aspects, no single one of which is solely responsible for the desirable attributes disclosed herein.

One innovative aspect of the subject matter described in this disclosure can be implemented in an electromechanical device, including an array of pixels including, for each respective pixel, at least one light modulator coupled between a first node and a second node, and control circuitry including, for the respective pixel, a first switch coupled to the first node for discharging an accumulated charge from the first node, a second switch coupled to the second node for discharging an accumulated charge from the second node, and a third switch coupled to the first switch, the second switch and a third node, the third switch capable of discharging an accumulated charge from the third node, wherein a gate of the third switch is coupled to a gate of the first switch.

In some implementations, the device can include a second switch where a gate of the second switch is coupled to a source of the third switch. In some implementations, the control circuitry can include a row line for enabling the pixel to respond to a data voltage, a column line for providing the data voltage to a first storage element, and an actuate line for providing an actuation voltage sufficient to actuate at least one light modulator. In some implementations, the control circuitry can include a V_{mid} line for providing a V_{mid} voltage to the third node, where the V_{mid} voltage is less than or equal to the actuation voltage. In some implementations, the control circuitry can include a pre-charge line for controlling application of the actuation voltage to the first and second nodes, and for controlling application of the V_{mid} voltage to the third node.

In some implementations, the control circuitry can include a fourth switch coupled to the actuate line, the pre-charge line and the first node, for controlling application of the actuation voltage to the first node, a fifth switch coupled to the actuate line, the pre-charge line and the second node, for controlling application of the actuation voltage to the second node, and a sixth switch coupled to the V_{mid} line, the pre-charge line and the third node, for controlling application of the V_{mid} voltage to the third node. In some implementations, at least one of the first, second, third, fourth, fifth and sixth switches can include a transistor.

In some implementations, the first storage element can be coupled to the gate of the first switch. In some implementations, the control circuitry can include a second storage element coupled between the third node and a shutter line. In some implementations, at least one of the first and second storage elements can include a capacitor.

In some implementations, the device can include a first electrostatic actuator coupled to the first node, and a second electrostatic actuator coupled to the second node, wherein the at least one light modulator is coupled between the first electrostatic actuator and the second electrostatic actuator, and the first and second electrostatic actuators are configured for moving the light modulator between a first position and a second position. In some implementations, the device can include, for each pixel at least one aperture, where the light modulator allows light to pass through the aperture in the first position, and blocks light from passing through the aperture in the second position. In some implementations, the light modulator can include a MEMS-based shutter.

In some implementations, the device can include a display, a processor that is configured to communicate with the display, the processor being configured to process image data, and a memory device that is configured to communicate with the processor. In some implementations, the device can include a driver circuit configured to send at least one signal to the display and a controller configured to send at least a portion of the image data to the driver circuit. In some implementations, the device can include an image source module configured to send the image data to the processor, where the image source module comprises at least one of a receiver, transceiver, and transmitter. In some implementations, the device can include an input device configured to receive input data and to communicate the input data to the processor.

Another innovative aspect of the subject matter described in this disclosure can be implemented in a method for addressing an array of pixels in a display wherein a given pixel includes a light modulator coupled between first and second nodes, including storing a data voltage on a first storage element, applying a high voltage to a pre-charge line, applying the high voltage to an update line and an enableB line, charging the first node and the second node to an actuate voltage, charging a third node to a V_{mid} voltage, applying a low voltage to the update line, applying the low voltage to the enableB line, and moving the light modulator to a first position based at least in part on the data voltage. In some implementations, the method can include discharging an accumulated charge from the first node and third node, wherein the third node discharges the accumulated charge faster than the first node. The some implementations, the low voltage can be applied to the enableB line after the third node is discharged. In some implementations, the array of pixels is addressed faster by applying a low voltage to the enableB line sooner.

Another innovative aspect of the subject matter described in this disclosure can be implemented in an electromechanical device, including an array of pixels including, for each respective pixel, light modulating means coupled between a first node and a second node, and control circuitry including, for the respective pixel, means for preventing charge injection at the first node. In some implementation, the control circuitry can include, for the respective pixel, means for preventing simultaneous discharge of the first node and the second node. In some implementations, the means for preventing charge injection at the first node can prevent charge injection from an enableB line.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCDs), organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A is an example of a display apparatus having MEMS elements.

FIG. 1B is a block diagram of the display apparatus of FIG. 1A.

FIG. 2A depicts in more detail a light modulator of the type depicted in FIG. 1A.

FIG. 2B depicts an alternate implementation of a light modulator of the type depicted in FIG. 1A.

FIG. 3A is a schematic diagram of a control matrix suitable for controlling the light modulators of the display apparatus of FIG. 1A.

FIG. 3B is a perspective view of an array of shutter-based light modulators connected to the control matrix of FIG. 3A.

FIGS. 4A and 4B are plan views of a dual-actuated light modulator assembly in the open and closed positions, respectively.

FIG. 5 is a circuit diagram of control circuitry for controlling a dual-actuated light modulator.

FIG. 6 is a circuit diagram of an alternate implementation of control circuitry for controlling a dual-actuated light modulator.

FIG. 7 is a circuit diagram of an alternate implementation of control circuitry, including the control circuitry of FIG. 6, for controlling a dual-actuated light modulator.

FIG. 8 is a block diagram of a method for operating the circuit of FIG. 7.

FIGS. 9A and 9B are system block diagrams illustrating a display device that includes a plurality of MEMS light modulator display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In certain implementations described herein, an electromechanical device may be provided with a fast symmetric drive pixel circuit for preventing charge injection across a first node and for reducing unwanted voltage discharge of an accumulated charge placed on the first node and a second node coupled to a light modulator. The fast symmetric drive pixel circuit may be part of control circuitry for controlling a light modulator in an array of pixels of a display device. The electromechanical device may include a movable element (e.g., a light modulator) coupled between a first actuator and a second actuator, the first and second actuators capable of moving the movable element between at least two positions. The first and second actuators may be coupled between first and second nodes, also referred to as ‘master’ and ‘slave’ nodes. The first node may be coupled to a first. The switch is typically a semiconductor device such as a transistor. The first switch may have a gate, a source and a drain. The second node may be coupled to a second switch having a gate, a source and a drain. The first switch may be configured to control discharge of voltage from the first node. The second switch may be configured to control discharge of voltage from the second node. The gate of the first switch may be coupled to the gate of a third switch, and the gate of the second switch may be coupled to a third node, also referred to as ‘node A.’ The source of the third switch may be coupled to node A, and a storage element may be coupled to node A. The third switch may be configured to control discharge of an accumulated charge from node A. A fourth switch may be coupled between node A and a ‘Vmid’ voltage line configured to provide an intermediate voltage to node A. The fourth switch may be configured to control application of the intermediate voltage to node A.

In certain implementation described herein, a method for addressing an array of pixels in a display device is provided. A given pixel in the array of pixels may include a light modulator coupled between a first node and a second node, a first switch coupled to the first node, and a second switch coupled between the second node and a node A. The method may provide charging the first and second nodes to an actuation voltage and charging node A to an intermediate voltage. For example, the first and second nodes may be coupled to an actuate line which provides an actuation voltage to the first and second nodes, and node A may be coupled to a V_{mid} line which provides an intermediate voltage to node A. The method may further include loading data to the array of pixels, and for a given pixel, and discharging node A faster than the first node and thereby preventing simultaneous discharge of both the first node and the second node. The method may further include preventing charge injection on the first node and maintaining a high enough voltage on the first node to cause actuation of the light modulator.

Particular implementations of the subject matter described in this disclosure can be implemented to realize one or more of the following potential advantages. The systems and methods described herein may reduce power loss during operation of control circuitry by preventing charge injection from the first node (e.g., the master node). Preventing charge injection may also ensure that the light modulator moves correctly by maintaining a high enough voltage on the first node to cause actuation of the light modulator. In addition, the systems and methods described herein may prevent simultaneous discharge of the first and second nodes, thereby preventing incorrect light modulator movement. Furthermore, the systems and methods described herein may increase the speed of the control circuitry operation because it is not necessary to wait for the first node to fully discharge during every light modulator movement cycle using this design.

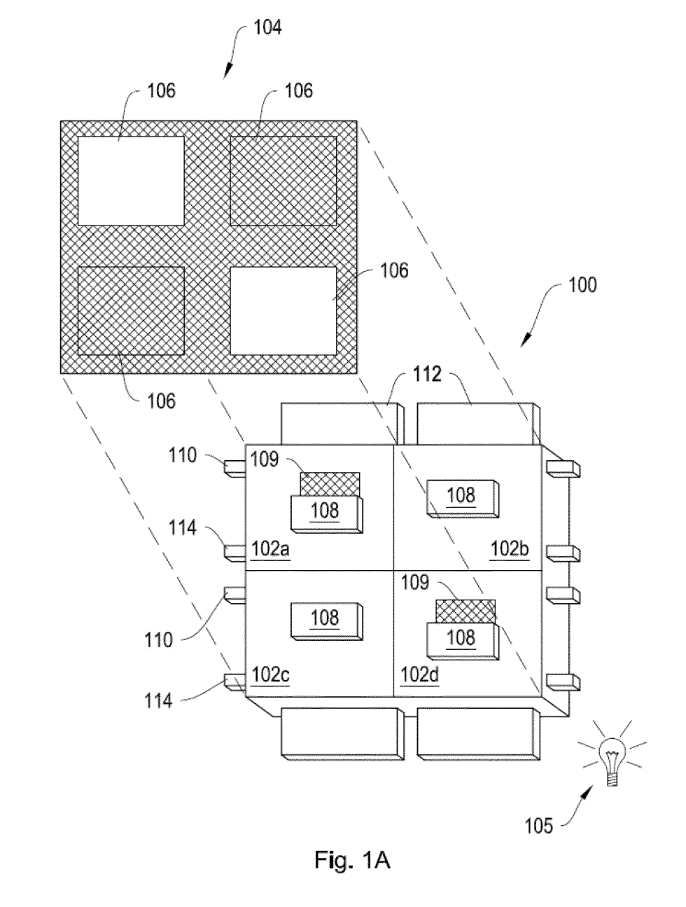

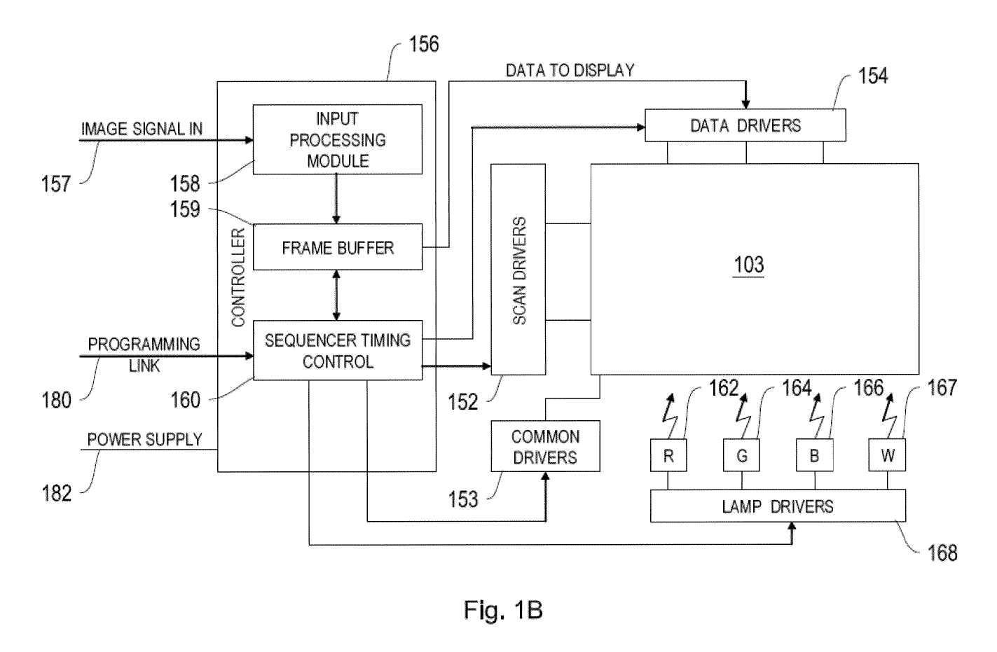

FIG. 1A is an example of a display apparatus 100, according to an illustrative implementation. The display apparatus 100 includes a plurality of MEMS light modulators 102a-102d (generally “light modulators 102”) arranged in rows and columns. In the display apparatus 100, light modulators 102a and 102d are in the open state, allowing light to pass. Light modulators 102b and 102c are in the closed state, obstructing the passage of light. By selectively setting the states of the light modulators 102a-102d, the display apparatus 100 can form an image 104 for a backlit display, if illuminated by a lamp or lamps 105. Setting the state of a MEMS modulation, such as MEMS modulator 102a, involves actuating the MEMS modulator 102a to move an element within the modulator 102a from a first position to a second position. The MEMS modulators 102a-102d may include a single actuator to move the light modulator, or may include a dual-actuator configuration. In a dual-actuator configuration a shutter 108 may be positioned between a first actuator and a second actuator. One or both of the first actuator and second actuator may be used to move the shutter into a fully open position to allow light to pass, a fully closed position to block light from passing, or a range of partially open positions to allow a select amount of light to pass through an aperture. The first actuator and second actuator may be coupled to control circuitry via a first node and a second node, respectively.

In another implementation, the apparatus may form an image by reflection of ambient light originating from the front of the apparatus. In another implementation, the apparatus may form an image by reflection of light from a lamp or lamps positioned in the front of the display, i.e. by use of a front light. In still another implementation, the apparatus may work in a transflective mode, reflecting both ambient light originating from the front of the apparatus and light from a backlight. In general, in one of the closed or open states, the light modulators 102 interfere with light in an optical path by, for example, and without limitation, blocking, reflecting, absorbing, filtering, polarizing, diffracting, or otherwise altering a property or path of the light.

In the display apparatus 100, each light modulator 102 corresponds to a pixel 106 in the image 104. In certain implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide grayscale in an image 104. With respect to an image, a “pixel” corresponds to the smallest picture element defined by the resolution of the image. With respect to structural components of the display apparatus 100, the term “pixel” refers to the combined mechanical and electrical components utilized to modulate the light that forms a single pixel of the image.

In the implementation depicted in FIG. 1A, each light modulator 102 includes a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material. In transflective implementations, each light modulator modulates both light from the backlight 105, as well as ambient light. In one implementation, the apertures are not completely cleared of the reflective material that would otherwise be etched away to form the aperture. The remaining reflective material reflects incident light back towards a viewer to form a part of the image 104. In another implementation, the apertures are fully cleared, and the ambient light is reflected by a front-facing reflective layer positioned behind the lamp 105.

The display apparatus 100 also includes a control matrix connected to the substrate and to the light modulators for providing a voltage to the actuators and for controlling the movement of the shutters. The control matrix may include active circuitry such as transistors, capacitors and other circuit elements. The control matrix provides electrical interconnections that allow for voltages to be applied to different components of the light modulator 102. In certain implementations, the control matrix includes a series of electrical interconnects (e.g., interconnects 110, 112, and 114), including a write-enable interconnect 110 (also referred to as a “scan-line interconnect”) per row of pixels, at least one data interconnect 112 for each column of pixels, and one common interconnect 114 providing a common voltage to all pixels, or at least to pixels from both multiple columns and multiples rows in the display apparatus 100. The electrical interconnects may be otherwise known as “lines.” In response to the application of an appropriate voltage (the “write-enabling voltage”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In other implementations, the data voltage pulses control switches, e.g., transistors or other non-linear circuit elements that control the application of separate actuation voltages, which are typically higher in magnitude than the data voltages, to the light modulators 102. The voltage may be applied to the light modulators 102 through electrical connections, or “nodes.” The application of these actuation voltages then results in the electrostatic driven movement of the shutters 108.

FIG. 1B is a block diagram of the display apparatus 100 of FIG. 1A, according to one illustrative implementation. Referring to FIGS. 1A and 1B, in addition to the elements of the display apparatus 100 described above, as depicted in the block diagram of FIG. 1B, the display apparatus 100 includes a plurality of scan drivers 152 (also referred to as “write enabling voltage sources”) and a plurality of data drivers 154 (also referred to as “data voltage sources”). The scan drivers 152 apply write enabling voltages to scan-line interconnects 110. The data drivers 154 apply data voltages to the data interconnects 112. In some implementations of the display apparatus, the data drivers 154 are configured to provide analog data voltages to the light modulators, especially where the gray scale of the image 104 is to be derived in analog fashion. In analog operation the light modulators 102 are designed such that when a range of intermediate voltages is applied through the data interconnects 112 there results a range of intermediate open states in the shutters 108 and therefore a range of intermediate illumination states or gray scales in the image 104. In other cases the data drivers 154 are configured to apply only a reduced set of 2 digital voltage levels to the control matrix. These voltage levels are designed to set, in digital fashion, either an open state or a closed state to each of the shutters 108.

The scan drivers 152 and the data drivers 154 are connected to digital controller circuit 156 (also referred to as the “controller 156”). The controller 156 controls how voltages are applied to different components of the light modulators to control how the light modulator moves relative to the aperture. The controller 156 includes an input processing module 158, which processes an incoming image signal 157 into a digital image format appropriate to the spatial addressing and the gray scale capabilities of the display 100. The pixel location and gray scale data of each image is stored in a frame buffer 159 so that the data can be fed out as needed to the data drivers 154. The data is sent to the data drivers 154 in mostly serial fashion, organized in predetermined sequences grouped by rows and by image frames. The data drivers 154 can include series to parallel data converters, level shifting, and for some applications digital to analog voltage converters.

The display apparatus 100 optionally includes a set of common drivers 153, also referred to as common voltage sources. In some implementations the common drivers 153 provide a DC common potential to all light modulators within the array of light modulators 103, for instance by supplying voltage to a series of common interconnects 114. In other implementations the common drivers 153, following commands from the controller 156, issue voltage pulses or signals to the array of light modulators 103, for instance global actuation pulses which are capable of driving and/or initiating simultaneous actuation of all light modulators in multiple rows and columns of the array 103.

The drivers (e.g., scan drivers 152, data drivers 154, and common drivers 153) for different display functions are time-synchronized by a timing-control module 160 in the controller 156. Timing commands from the module 160 coordinate the illumination of red, green and blue and white lamps (162, 164, 166, and 167 respectively) via lamp drivers 168, the write-enabling and sequencing of specific rows within the array of pixels 103, the output of voltages from the data drivers 154, and the output of voltages that provide for light modulator actuation.

The controller 156 determines the sequencing or addressing scheme by which each of the shutters 108 in the array 103 and lamps 162, 164, 166, and 167 can be re-set to the illumination levels appropriate to a new image 104. New images 104 can be set at periodic intervals. For instance, for video displays, the color images 104 or frames of video are refreshed at frequencies ranging from 10 to 300 Hertz. In some implementations the setting of an image frame to the array 103 is synchronized with the illumination of the lamps 162, 164, and 166 such that alternate image frames are illuminated with an alternating series of colors, such as red, green, and blue, to provide field sequential color.

In alternative implementations, the array of pixels 103 and the control matrix that controls the pixels may be arranged in configurations other than rectangular rows and columns. For example, the pixels can be arranged in hexagonal arrays or curvilinear rows and columns. In general, as used herein, the term scan-line shall refer to any plurality of pixels that share a write-enabling interconnect.

In some implementations, the array of modulators may be divided into two or more groups with different spatial orientations with respect to their respective apertures. The input processing module 158 may additionally store a map of the spatial orientation of each pixel and process control signals prior to sending them on to the control matrix to determine the direction of motion to actuate each modulator from a light-blocking state to a light-transmissive state.

The display 100 includes a plurality of functional blocks including the timing control module 160, the frame buffer 159, scan drivers 152, data drivers 154, and drivers 153 and 168. Each block can be understood to represent either a distinguishable hardware circuit and/or a module of executable code. In some implementations the functional blocks are provided as distinct chips or circuits connected together by means of circuit boards and/or cables. Alternately, many of these circuits can be fabricated along with the pixel array 103 on the same substrate of glass or plastic. In other implementations, multiple circuits, drivers, processors, and/or control functions from block diagram 150 may be integrated together within a single silicon chip, which is then bonded directly to the transparent substrate holding pixel array 103.

The controller 156 includes a programming link 180 by which the addressing, color, and/or gray scale algorithms, which are implemented within controller 156, can be altered according to the needs of particular applications. Additionally, the programming link 180 may allow for different light modulator actuation techniques to be implemented, for example, to control the manner in which elements are moved within the light modulator. Thus, modulators that can move elements at different speeds may store and apply various algorithms to control the speed of modulation. In some implementations, the programming link 180 conveys information from environmental sensors, such as ambient light or temperature sensors, so that the controller 156 can adjust imaging modes or backlight power in correspondence with environmental conditions. The controller 156 also includes a power supply input 182 which provides the power needed for lamps as well as light modulator actuation. The drivers 152 153, 154, and/or 168 may also include or be associated with DC-DC converters for transforming an input voltage at 182 into various voltages sufficient for the actuation of shutters 108 or illumination of the lamps, such as lamps 162, 164, 166, and 167.

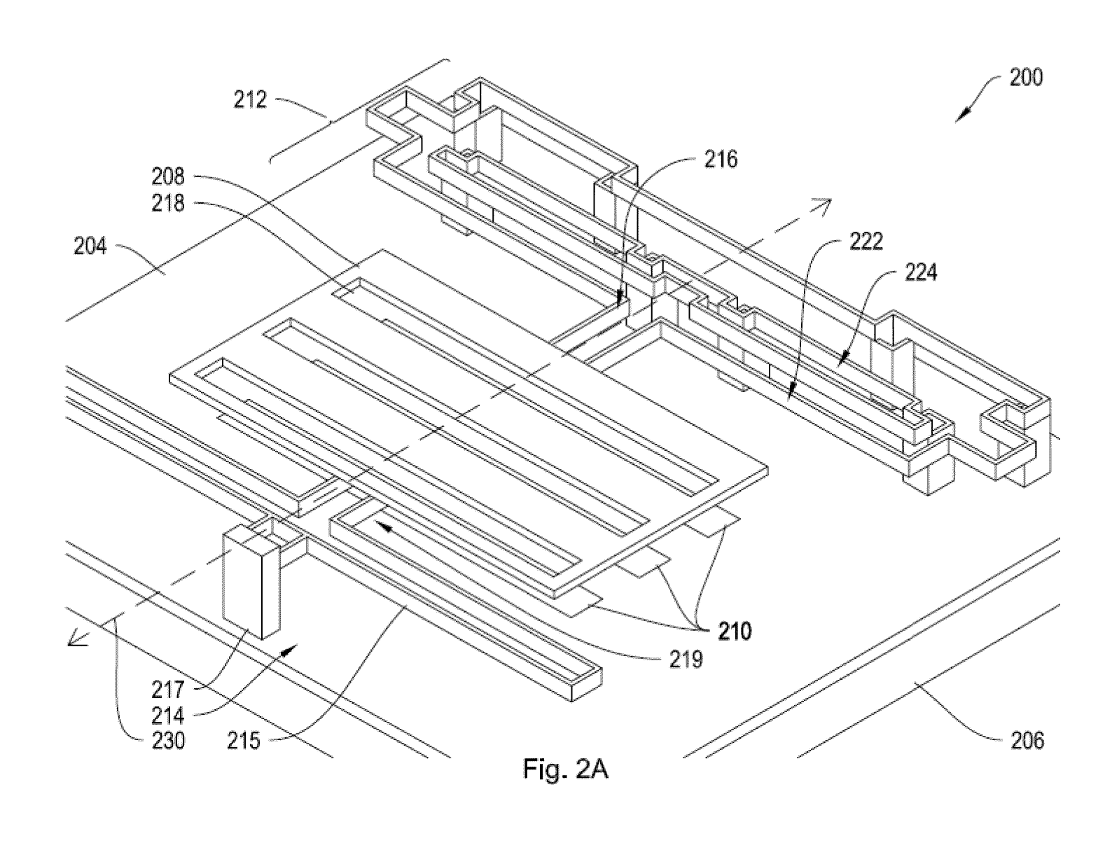

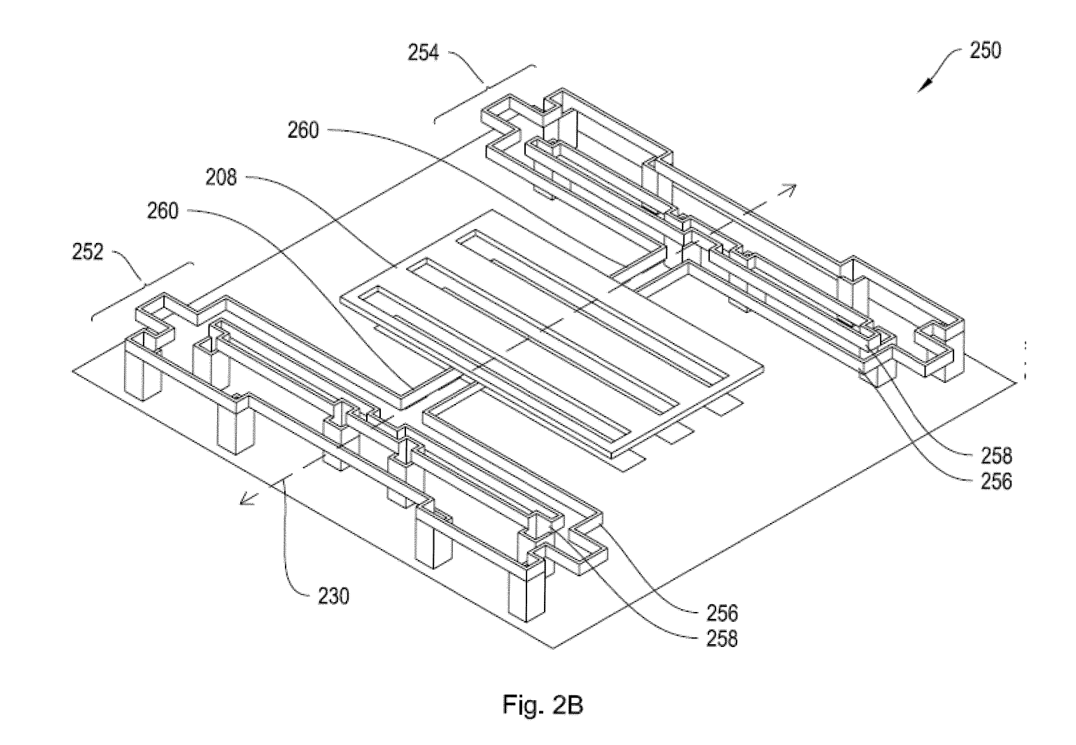

FIG. 2A depicts in more detail a light modulator of the type depicted in FIG. 1A. In particular, FIG. 2A depicts a light modulator 200 that may be used as the light modulators 102A-102D depicted in FIG. 1A. The light modulator 200 includes a MEMS shutter 208, and a single actuator 212 disposed on a substrate 204 that is positioned on a light guide 206. The light modulator 200 is backlit and lamps, such as the lamps 162-167 of FIG. 1B, can illuminate the light guide 206. The light guide 206 distributes the lamp light beneath the substrate 204 to allow light to pass through the apertures 210 that are formed within the substrate 204. The apertures 210 may be openings, such as holes, formed in the substrate 204 to provide a path for light within the light guide 206 to pass toward the shutter 208. Alternatively, the apertures 210 may be transparent regions formed in the surface of the substrate 204 to allow light to pass from the light guide 206 to the shutter 208. In either case, the apertures 210 allow light to pass from the light guide 206 toward the shutter 208. The shutter 208 includes three apertures 218 that can be aligned with the apertures 210 by action of the actuator 212. The apertures 218 in shutter 208 may be through holes formed within the shutter 208 to allow light passing through the shutter 208. In certain other implementations, the apertures 218 are formed by providing an optically transparent material that allows light passing through substrate apertures 210 to pass through the shutter 208. In the implementation depicted in FIG. 2A, the shutter 208 has three apertures 218, each of which is a rectangle and each of which can be aligned with a respective rectangular substrate aperture 210. In other implementations, the shutter 208 and the substrate 204 may have more or fewer apertures and the apertures may be of different geometries. The number of apertures and their geometries will vary according to the specifications provided for the display.

In the single actuator light modulator assembly 200, a spring 214 attaches to the shutter 208 on a side of the shutter 208 opposite the actuator 212. The spring 214 includes a compliant beam 215. The compliant beam 215 may be a pliant wall of elastic semiconductor material, such as a pliant wall of amorphous silicon. In the depicted implementation, the compliant beam 215 is formed as a rectangular wall of elastic semiconductor material. On one side, the compliant beam 215 couples to a standoff anchor 217 that fixes one side of the rectangular compliant beam 215 to the substrate 204. The standoff anchor 217 also holds the compliant beam 215 away from the surface of the substrate 204, so that there is a separation between the compliant beam 215 and the surface of the substrate 204. The opposite side of the rectangular compliant beam 215 couples to a pair of connecting arms 219 that couples the compliant beam 215 to the shutter 208. The spring 214 provides a restorative force to the shutter 208. For example, when the shutter 208 is moved toward the actuator 212 in response to the actuator 212 being activated by a controller, such as the controller 156, the compliant beam 215 deforms by extending in the direction that the shutter 208 has moved. The deformed compliant beam 215 generates a spring force that opposes the motion of the shutter 208 toward the actuator 212. When the controller 156 deactivates the actuator 212, the spring force of the compliant beam 215 pulls the shutter 208 away from the actuator 212 into the position the shutter 208 was in before the actuator 212 drove the shutter 208 away from the spring 214.

The shutter 208 connects to a connecting rod 216 that connects to the actuator 212. The actuator 212 drives the shutter 208 in a path along the direction of the axis 230. The actuator 212, in certain implementations, connects to an interconnect layer formed within the substrate 204. The interconnect layer provides a control matrix like the control matrix described with reference to FIGS. 1A and 1B. The actuator 212 includes an electrode 222 and an electrode 224. The electrode 222 connects to the connecting rod 216 that also connects to the shutter 208. The electrodes 222 and 224 and the connecting rod 218 may be made from any suitable material, and for example may be made from a semiconductor material such as amorphous silicon, epitaxial silicon or any other suitable material. The electrode 222 faces the electrode 224. In the implementation depicted in FIG. 2A, the connecting rod 216 couples the shutter 208 to the center of the electrode 222. The pair of electrodes 222 and 224 are drive electrodes that will, when activated, drive the electrode 222 toward the electrode 224, which drives the shutter 208 along a path defined by the axis 230. The spring 214 attached to the shutter 208 provides a restoring force that pulls the shutter 208 back toward the spring 214 when the actuator 212 is no longer actuating the drive electrodes 222 and 224.

FIG. 2B depicts, in more detail, an alternate implementation of a light modulator of the type depicted in FIG. 1A. In particular, FIG. 2B depicts a dual-actuated light modulator 250 having opposing actuators 252 and 254. The light modulator 250 of FIG. 2B may be used as the light modulators 102A-102D depicted in FIG. 1A. Each of actuators 252 and 254 is similar in structure and operation to the actuator 212 of FIG. 2A. In the implementation of FIG. 2B the shutter 208 connects on opposite sides to respective ones of the actuators 252 and 254. The actuators 252 and 254 and suspend the shutter 208 a distance away from the substrate 204.

Similarly to the single actuator light modulator assembly 200 of FIG. 2A, the actuators 252 and 254 each include electrodes 256 and 258. The electrode 222 connects to the connecting rod 216 that also connects to the shutter 208. The electrodes 256 and 258 may be made from any suitable material, and for example may be made from a semiconductor material such as amorphous silicon, epitaxial silicon or any other suitable material. The electrode 256 faces the electrode 258. In the implementation depicted in FIG. 2B, a connecting rod 260 couples the shutter 208 to the center of the electrodes 256 and 258. The pair of electrodes 256 and 258 are drive electrodes that will, when activated, drive the electrode 256 toward the electrode 258, which drives the shutter 208 along a path defined by the axis 230. By providing an electrical potential to electrodes 256 and 258, a capacitance is created between the electrodes 256 and 258. This allows actuators 252 and 254 to act as capacitors. In this implementation, a controller, such as controller 156, may control the operation of each actuator 252 and 254, via a node coupled to each actuator, to move the shutter 208 in a direction along the axis 230 to modulate light.

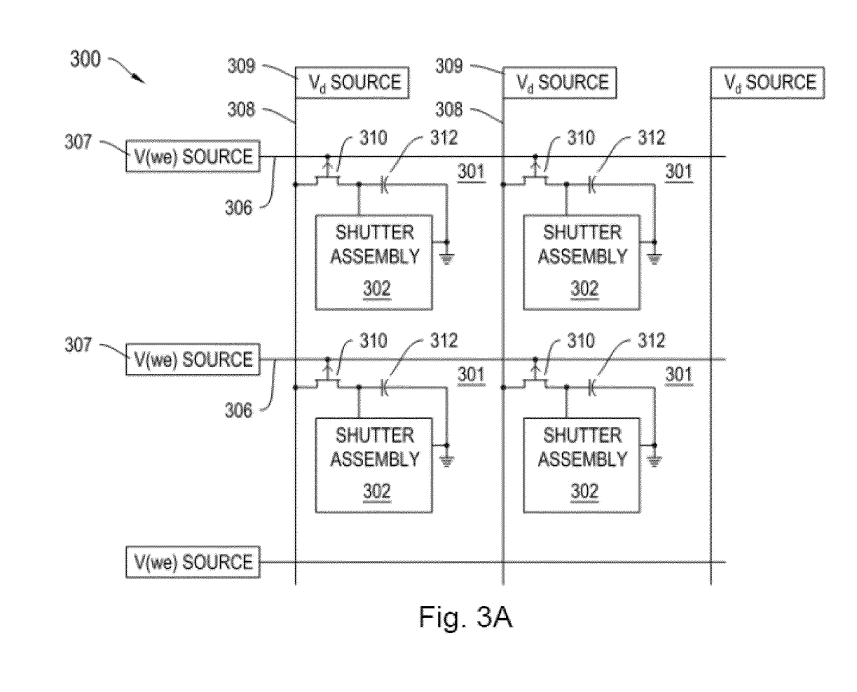

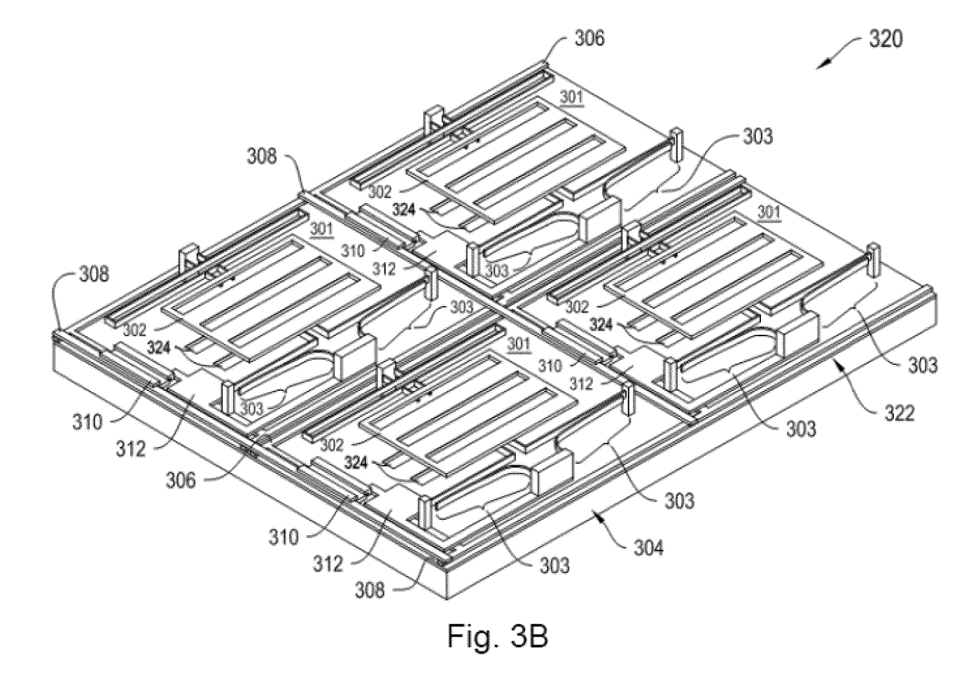

FIG. 3A is a schematic diagram of one control matrix 300 suitable for controlling the light modulators incorporated into the MEMS-based display apparatus 100 of FIG. 1A. FIG. 3B is a perspective view of an array 320 of shutter-based light modulators connected to the control matrix 300 of FIG. 3A. The control matrix 300 may include control circuitry for controlling operation of a pixel in an array of pixels 320 (the “array 320”). In the example shown in FIGS. 3A and 3B, each pixel 301 includes an elastic shutter assembly 302, such as the shutter assembly 200 of FIG. 2A, controlled by a single actuator 303. However, in certain implementations, each pixel 301 may include a dual-actuated shutter assembly, such as the shutter assembly shown in FIG. 2B. Each pixel 301 also includes an aperture layer 322 that includes apertures 324.

The control matrix 300, including control circuitry, may be fabricated as a diffused or thin-film-deposited electrical circuit on the surface of a substrate 304 on which the shutter assemblies 302 are formed. The control circuitry of control matrix 300 may include a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source, (“V_{d} source”) 309 to the pixels 301 in a corresponding column of pixels 301. In implementations using dual-actuated shutter assemblies, the control matrix 300 may include two data interconnects for each pixel 301 for controlling the dual-actuated shutter assemblies 302. In control matrix 300, the data voltage V_{d} provides the majority of the energy for actuation of the shutter assemblies 302. Thus, the data voltage source 309 also serves as an actuation voltage source. In certain implementation, an actuation voltage source may provide the majority of energy for actuation of the shutter assemblies 300.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog grayscale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly 302 actuates, opening the shutter in that shutter assembly 302. The voltage applied to the data interconnect 308 remains stored in the capacitor 312 of the pixel 301 even after the control matrix 300 ceases to apply V_{we} to a row. It is not needed, therefore, to wait and hold the voltage V_{we} on a row for times long enough for the shutter assembly 302 to actuate; such actuation can proceed after the write-enabling voltage has been removed from the row. The capacitors 312 also function as storage elements within the array 320, storing actuation instructions for periods as long as is needed for the illumination of an image frame.

The pixels 301 as well as the control matrix 300 of the array 320 are formed on a substrate 304. The array includes an aperture layer 322, disposed on the substrate 304, which includes a set of apertures 324 for respective pixels 301 in the array 320. The apertures 324 are aligned with the shutter assemblies 302 in each pixel. In one implementation the substrate 304 is made of a transparent material, such as glass or plastic. In another implementation the substrate 304 is made of an opaque material, but in which holes are etched to form the apertures 324.

Components of shutter assemblies 302 are processed either at the same time as the control matrix 300 or in subsequent processing steps on the same substrate. The electrical components in control matrix 300 are fabricated using many thin film techniques in common with the manufacture of thin film transistor arrays for liquid crystal displays. The shutter assemblies are fabricated using techniques similar to the art of micromachining or from the manufacture of micromechanical (i.e., MEMS) devices. For instance, the shutter assembly 302 can be formed from thin films of amorphous silicon, deposited by a chemical vapor deposition process.

The shutter assembly 302 together with the actuator 303 can be made bi-stable. That is, the shutters can exist in at least two equilibrium positions (e.g. open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 can also be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as spring 207 in shutter-based light modulator 200, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on” or “off” optical states in each pixel. Certain forms of coded area division grayscale are possible where multiple MEMS light modulators in the pixel are provided, and where apertures 324, which are associated with each of the light modulators, have unequal areas.

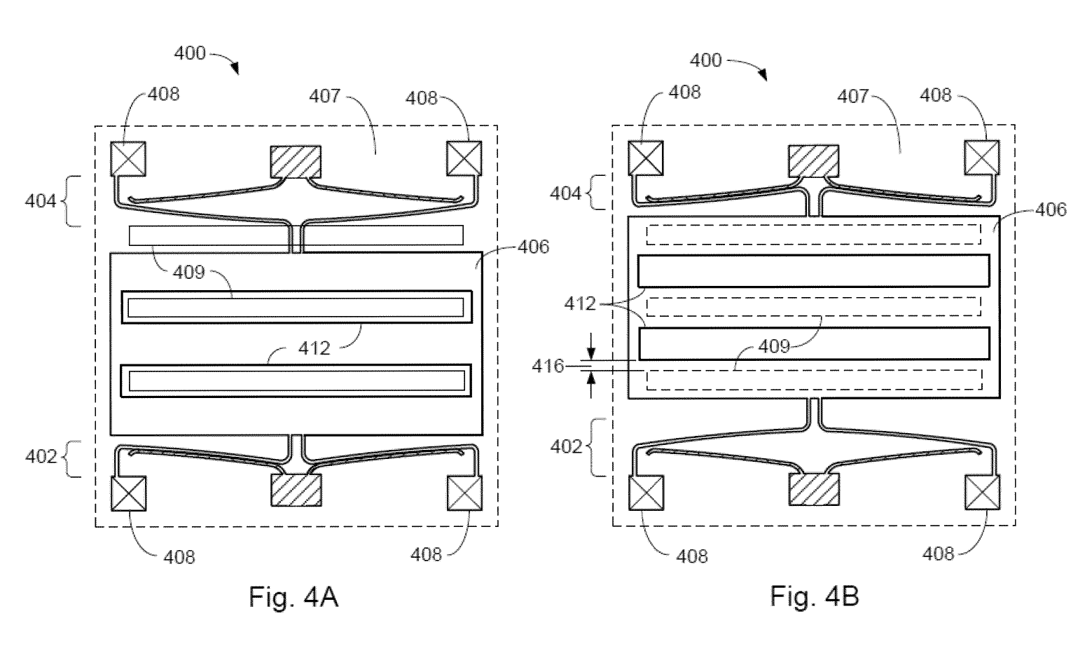

FIGS. 4A and 4B are plan views of a dual-actuated shutter assemblies in the open and closed states respectively. In particular, FIGS. 4A and 4B illustrate an alternative shutter-based light modulator (shutter assembly) 400 suitable for inclusion in the MEMS-based display apparatus 100 of FIG. 1A, and the array of pixels 300 and 320 of FIGS. 3A and 3B. The light modulator 400 is an example of a dual actuator shutter assembly, and is shown in FIG. 4A in an open state. FIG. 4B is a view of the dual actuator shutter assembly 400 in a closed state. In contrast to the single-actuator shutter assembly 200, shutter assembly 400 includes opposing actuators 402 and 404 on either side of a shutter 406. Each actuator 402 and 404 is coupled to the control matrix via a first node and a second node, respectively (e.g., a ‘master node’ and a ‘slave node’) and each actuator 402 and 404 may be independently controlled. A first actuator, a shutter-open actuator 402, serves to open the shutter 406. A second opposing actuator, the shutter-close actuator 404, serves to close the shutter 406. Both actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of motion reduces out of plane motion of the shutter 406 and confines the motion substantially to a plane parallel to the substrate. By analogy to the control matrix 300 of FIG. 3A, a control matrix suitable for use with shutter assembly 400 might include one transistor and one capacitor for each of the opposing shutter-open and shutter-close actuators 402 and 404.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of apertures 412 and 409 coincide. In FIG. 4B the shutter assembly 400 has been moved to the closed state and the shutter-open actuator 402 is in its relaxed position. The shutter-close actuator 404 has been actuated, and the light blocking portions of shutter 406 are in position to block transmission of light through the apertures 409 (shown as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In other implementations the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

To allow light with a variety of exit angles to pass through apertures 412 and 409 in the open state, it is advantageous to provide a width or size for shutter apertures 412 which is larger than a corresponding width or size of apertures 409 in the aperture layer 407. To effectively block light from escaping in the closed state, the light blocking portions of the shutter 406 may be arranged to overlap the apertures 409. FIG. 4B shows a predefined overlap 416 between the edge of light blocking portions in the shutter 406 and one edge of the aperture 409 formed in aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

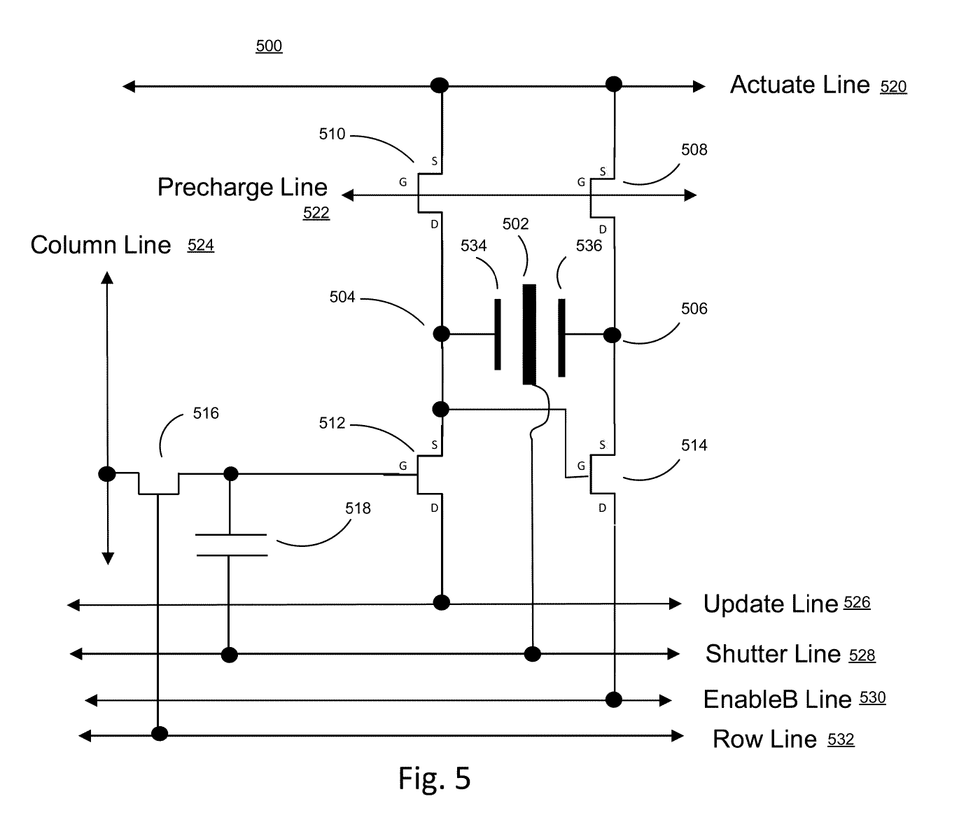

FIG. 5 is a circuit diagram of control circuitry 500 for controlling a dual-actuated light modulator assembly 502, such as the dual-actuated light modulator 250 of FIG. 2B or the dual-actuated light modulator 400 of FIGS. 4A and 4B. In particular, FIG. 5 illustrates the electrical connections for controlling a single pixel in an array of pixels, such as the array of pixels depicted in FIGS. 3A and 3B.

Circuit diagram 500 includes light modulator 502 coupled between electrodes 534 and 536. For simplicity, light modulator 502 and electrodes 534 and 536 are represented as vertical lines in circuit diagram 500, however light modulator 502 and electrodes 534 and 536 may resemble the structure of the dual-actuator light modulator assemblies as described with respect to FIGS. 2A and 2B, and/or FIGS. 4A and 4B. Electrode 534 is electrically coupled to first node 504, and electrode 536 is electrically coupled to second node 506. A node may be a connection point for two or more electrical interconnects or circuit elements. Light modulator 502 is electrically coupled to shutter line 528 so that a voltage placed on shutter line 528 will be applied to light modulator 502. Shutter line 528 provides a voltage to light modulator 502 (e.g., ground voltage) and can be used to control the voltage applied to the light modulator 502. In certain implementations, a high voltage may be applied to shutter line 528. Precharge switches 510 and 508 are coupled to first node 504 and 506, respectively. Actuate line 520 and precharge line 522 are electrically coupled to precharge switches 508 and 510. Actuate line 520 provides an actuation voltage sufficient to actuate light modulator 502 to move it to the intended position. Precharge line 522 controls the precharge switches 508 and 510 by applying a voltage to the gate of the precharge switch 508 (labeled as ‘G’) and to the gate of the precharge switch 510, thus turning the precharge switch 508 and the precharge switch 510 ‘ON,’ and allowing precharge switches 508 and 510 to pass an actuation voltage from the actuate line 520 to charge first node 504 and second node 506 to an actuation voltage.

Discharge switch 512 is electrically coupled between first node 504 and update line 526. Discharge switch 514 is electrically coupled between second node 506 and enableB line 530. The gate of discharge switch 514 is electrically coupled to first node 504. The gate of discharge switch 512 is electrically coupled to data switch 516 and to storage element 518. Data switch 516 is electrically coupled to column line 524. Column line 524 is configured to provide a data voltage, through data switch 516, to storage element 518, the data voltage corresponding to the intended position of light modulator 502. Row line 532, coupled to the gate of data switch 516, provides a voltage to control switch 516 to allow a data voltage to be stored on storage element 518. Application of a data voltage is described in more detail with respect to FIGS. 1A, 1B and 3A. In control circuitry 500, the data voltage controls discharge switch 512.

During operation of control circuitry 500, to move the light modulator 502 both the first node 504 and second node 506 are pre-charged to an actuation voltage high enough to move the light modulator 502. Then, one of the first node 504 or second node 506 is discharged, in accordance with the data voltage stored on storage element 518, to move the light modulator 502 to its intended position (e.g., ‘open’ or ‘closed’). For example, if the data voltage provided by column line 524 is ‘HIGH,’ discharge switch 512 is turned ‘ON’ and the charge on first node 504 may be discharged when the update line 526 is held at a ‘LOW’ voltage. Because, after discharge, the voltage on first node 504 is ‘LOW,’ discharge switch 514 will remain ‘OFF’ and second node 506 will be maintained at a ‘HIGH’ voltage (e.g., actuation voltage). When the charge on first node 504 is discharged, the charge on electrode 534 is also discharged. Because the second node 506 is maintained at a ‘HIGH’ voltage, the voltage across electrode 536 is a ‘HIGH’ voltage. Thus, if the light modulator 502 is held at a low voltage by shutter line 528, an attractive electrostatic force will be created between the light modulator 502 and electrode 536 and the light modulator 502 will move toward electrode 536. If the data voltage provided by the column line 514 is ‘LOW,’ discharge switch 512 remains ‘OFF’ and the voltage on the first node 504 is maintained at a ‘HIGH’ voltage (e.g., actuation voltage). Because the voltage on the first node 504 is ‘HIGH,’ discharge switch 514 is turned ‘ON’ and the charge on the second node 506 may be discharged when a ‘LOW’ voltage is applied to the enableB line 530. Because, after discharge, the voltage on second node 506 is ‘LOW,’ the voltage across electrode 536 will also be ‘LOW.’ Because the first node 504 is maintained at a ‘HIGH’ voltage, the voltage across electrode 534 is a ‘HIGH’ voltage. Thus, if the light modulator 502 is held at a low voltage by shutter line 528, an attractive electrostatic force will be created between the light modulator 502 and electrode 534 and the light modulator 502 will move toward electrode 534.

During operation, applying a low voltage to the enableB line 530 can cause charge injection through discharge switch 514 thus dragging down the voltage on the first node 504 and preventing the light modulator 502 from actuating correctly. In addition, when the data voltage is ‘HIGH,’ if the first node 504 does not fully discharge before a ‘LOW’ voltage is applied to the enableB line 530, then discharge switch 514 may be incorrectly turned ‘ON,’ thus resulting in simultaneous discharge of both the first node 504 and second node 506. The simultaneous discharge of the first node 504 and second node 506 may result in an incorrect actuation of the light modulator 502. Furthermore, extra time is required to fully discharge the entire first node 504 prior to applying a ‘LOW’ voltage to enableB line 530 and switching the light modulator 502, resulting in slower display operation times.

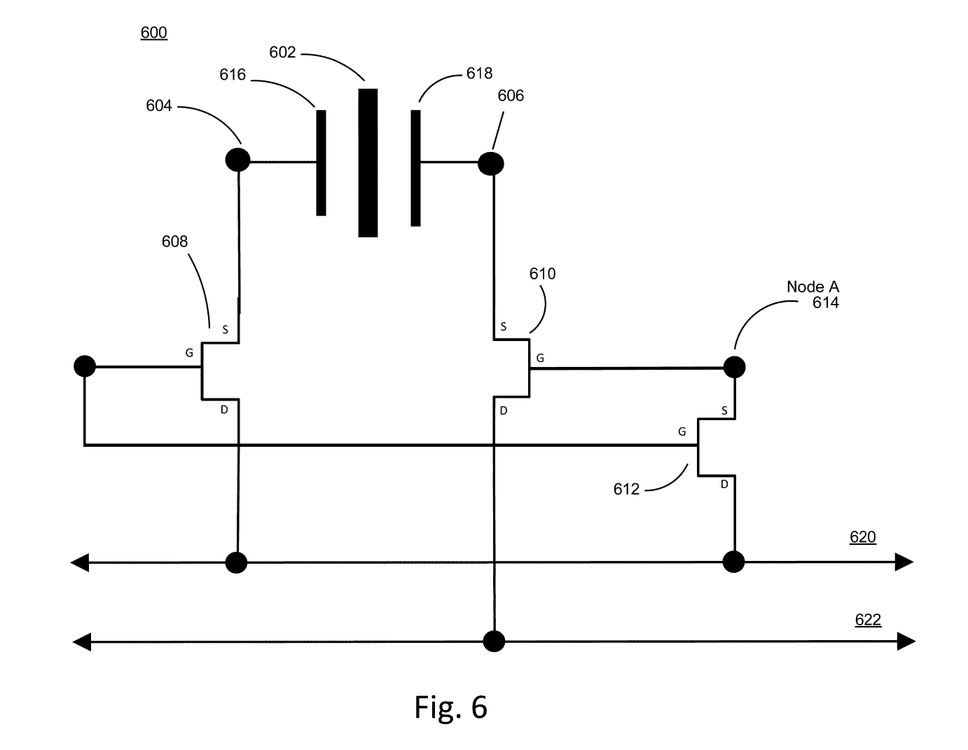

FIG. 6 is a circuit diagram 600 of an alternate implementation of control circuitry for controlling a dual-actuated light modulator 602, such as the dual-actuated light modulator 250 of FIG. 2B or the dual-actuated light modulator 400 of FIGS. 4A and 4B. In particular, FIG. 6 illustrates the electrical connections for controlling a single pixel in an array of pixels, such as the array of pixels depicted in FIGS. 3A and 3B. Circuit diagram 600 includes light modulator 602 coupled between electrodes 616 and 618. For simplicity, light modulator 602 and electrodes 616 and 618 are represented as vertical lines in circuit diagram 600, however light modulator 602 and electrodes 616 and 618 may resemble the structure of the dual-actuator light modulator assemblies as described with respect to FIGS. 2A and 2B, and/or FIGS. 4A and 4B. Electrode 616 is electrically coupled to a first node 604, and electrode 618 is electrically coupled to a second node 606.

In circuit diagram 600, discharge switch 608 is electrically coupled between first node 604 and electrical interconnect 620. Discharge switch 610 is electrically coupled between second node 606 and electrical interconnect 622. Unlike the control circuitry 500 of FIG. 5, in the control circuitry 600, the gate (labeled as ‘G’) of the discharge switch 610 is coupled to node A 614. Furthermore, control circuitry 600 includes a switch 612 coupled between node A 614 and an electrical interconnect 620. The gate of discharge switch 610 is coupled to the source of switch 612. The gate of switch 612 is coupled to the gate of discharge switch 608. In some implementations, the capacitance of node A 614 can be up to about 10 times lower than the capacitance of the first node 604. Node A may have a lower capacitance as a result of an intrinsic capacitance of switches 610 and 612. In certain implementations, node A may have a lower capacitance by ensuring minimum overlap of node A with any other node. Since node A does not drive light modulator 602 directly, it can be kept at a minimum capacitance. For example, the first node 604 may have a capacitance of approximately 150 fF, while node A 614 may have a capacitance of approximately 10-15 fF. The capacitance of node 604 may be made larger by adding extra overlap capacitances to ensure enough charge reservoir to drive light modulator 602. The lower capacitance of node A 614 when compared to the first node 604 allows node A 614 to discharge faster than the first node 604 when both switches 608 and 612 are turned ‘ON’ simultaneously. For example, node A 614 discharges a HIGH voltage through switch 612 (when switch 612 is turned ON) faster than the first node 604 discharges a HIGH voltage through switch 608 assuming switches 608 and 612 are substantially identical. Because node A 614 discharges a voltage faster than the first node 604, discharge switch 610, which is coupled to node A 614, is prevented from being turned ‘ON’ prematurely. Therefore, control circuitry 600 prevents simultaneous discharge of an accumulated charge from both the first node 604 and second node 606. Also, because node A 614 discharges faster, a low voltage can be applied to line 622 sooner than when compared to circuit 500 of FIG. 5. This allows for faster operation of the display device, including faster bit planes (sub frames). Furthermore, connecting the gate of discharge switch 610 to node A 614 instead of to the first node 604 (as it is done in control circuitry 500) prevents charge injection from the first node 604 through switch 610. Preventing charge injection allows a high enough voltage to be maintained on the first node 604 to cause actuation of the light modulator 602. The prevention of charge injection through the discharge switch 610 also saves power in the display device and prevents incorrect light modulator 602 actuation.

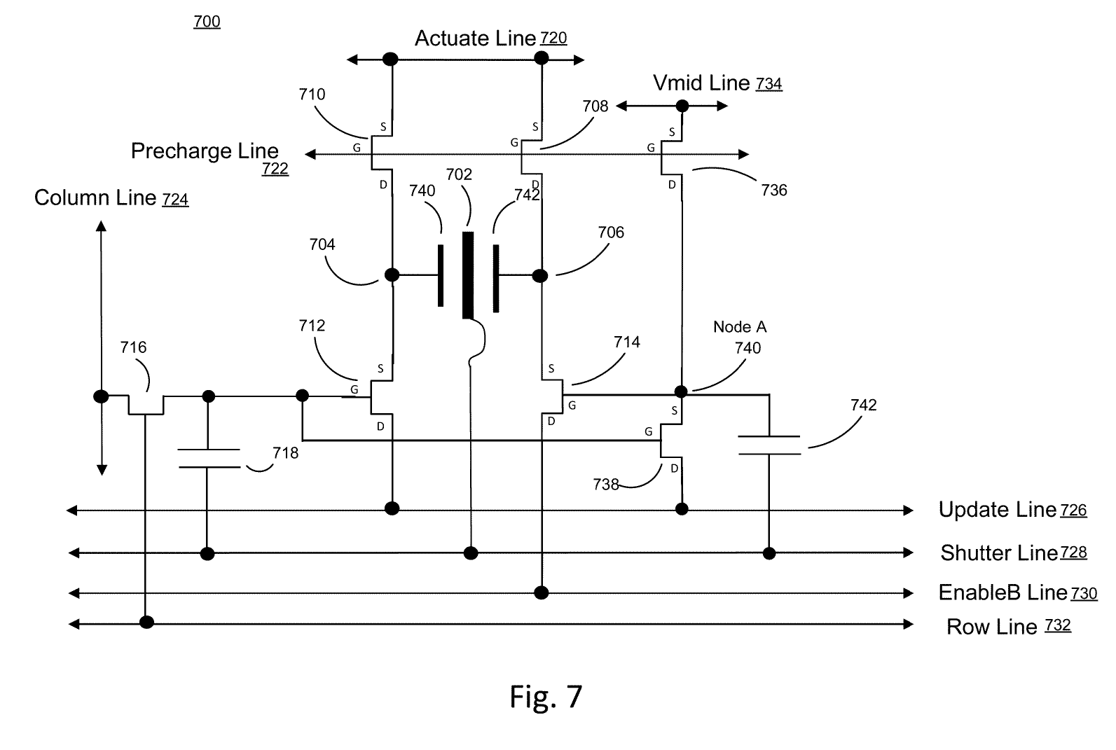

FIG. 7 is a circuit diagram 700 of an alternate implementation of control circuitry for controlling a dual-actuated light modulator, such as the dual-actuated light modulator 250 of FIG. 2B or the dual-actuated light modulator 400 of FIGS. 4A and 4B. Circuit diagram 700 includes the control circuitry 600 as described with respect to FIG. 6, above. In particular, FIG. 7 illustrates the electrical connections for controlling a single pixel in an array of pixels, such as the array of pixels depicted in FIGS. 3A and 3B. Circuit diagram 700 includes light modulator 702 coupled between electrodes 740 and 742. For simplicity, light modulator 702 and electrodes 740 and 742 are represented as vertical lines in circuit diagram 700, however light modulator 702 and electrodes 740 and 742 may resemble the structure of the dual-actuator light modulator assemblies as described with respect to FIGS. 2A and 2B, and/or FIGS. 4A and 4B. Electrode 740 is electrically coupled to first node 704, and electrode 742 is electrically coupled to second node 706. Light modulator 702 is electrically coupled to shutter line 728. Shutter line 728 is configured to provide a voltage to light modulator 702 (e.g., ground voltage). In certain implementations, shutter line 728 may provide a high voltage to light modulator 702. Precharge switches 710 and 708 are coupled to first node 704 and second node 706, respectively. Actuate line 720 and precharge line 722 are electrically coupled to precharge switches 708 and 710. Actuate line 720 is configured to provide an actuation voltage sufficient to actuate light modulator 702. Precharge line 722 controls precharge switches 708 and 710 by applying a voltage to the gate (labeled as ‘G’) of precharge switch 708 and to the gate of precharge switch 710, thus turning the precharge switch 708 and the precharge switch 710 ‘ON,’ and allowing precharge switches 708 and 710 to pass an actuation voltage from the actuate line 720 to charge first node 704 and second node 706 to an actuation voltage.

Discharge switch 712 is electrically coupled between first node 704 and update line 726. Discharge switch 714 is electrically coupled between second node 706 and enableB line 730. The gate of discharge switch 714 is electrically coupled to node A 740 and to the source of switch 738. The gate of discharge switch 712 is electrically coupled to data switch 716, to storage element 718 and to the gate of switch 738. Switch 738 is coupled between node A 740 and update line 726. Data switch 716 is electrically coupled to column line 724. Column line 724 is configured to provide a data voltage to storage element 718 corresponding to the intended position of light modulator 702. Row line 732, coupled to the gate of data switch 716, provides a voltage to control data switch 716 to allow a data voltage to be stored on storage element 718. Application of a data voltage is described in more detail with respect to FIGS. 1A, 1B and 3A. In control circuitry 700, the data voltage controls discharge switch 712 and switch 738. Switch 736 is electrically coupled between V_{mid} line 734 and node A 740. The gate of switch 736 is electrically coupled to precharge line 722. V_{mid} line 734 is configured to provide an intermediate voltage to node A 740. Precharge line 722 controls switch 736 by applying a voltage to the gate of switch 736 and allowing the intermediate voltage carried by the V_{mid} line 734 to charge node A 740 and storage element 744. The intermediate voltage applied by the V_{mid} line 734 may be stored on storage element 744.

In some implementations, the capacitance of node A 740 can be up to 10 times lower than the capacitance of the first node 704. For example, the first node 704 may have a capacitance of approximately 150 fF, while node A 740 may have a capacitance of approximately 10-15 fF. The lower capacitance of node A 740 when compared to the first node 704 allows node A 740 to discharge an accumulated charge faster than the first node 704 when both switches 712 and 738 are turned ‘ON.’ In addition, since the first node 704 is charged to an actuation voltage and node A 740 is charged to an intermediate voltage lower than the actuation voltage, node A 740 is able to discharge faster than the first node 704. Because node A 740 discharges faster than the first node 704, discharge switch 714 is prevented from being turned ‘ON’ prematurely. Therefore, control circuitry 700 prevents simultaneous discharge of both the first node 704 and second node 706. Also, because node A 740 discharges faster, a low voltage can be applied to EnableB line 730 sooner when compared to circuit diagram 500 of FIG. 5. This allows for faster operation of the display device including faster bit planes (sub frames). Furthermore, connecting the gate of discharge switch 714 to node A 740 instead of to the first node 704 prevents charge injection on the first node 704 through discharge switch 714, and maintains a high enough voltage on the first node 704 to cause actuation of the light modulator 702. The prevention of charge injection through the discharge switch 714 may save power in the display device and prevents incorrect actuation of light modulator 702.

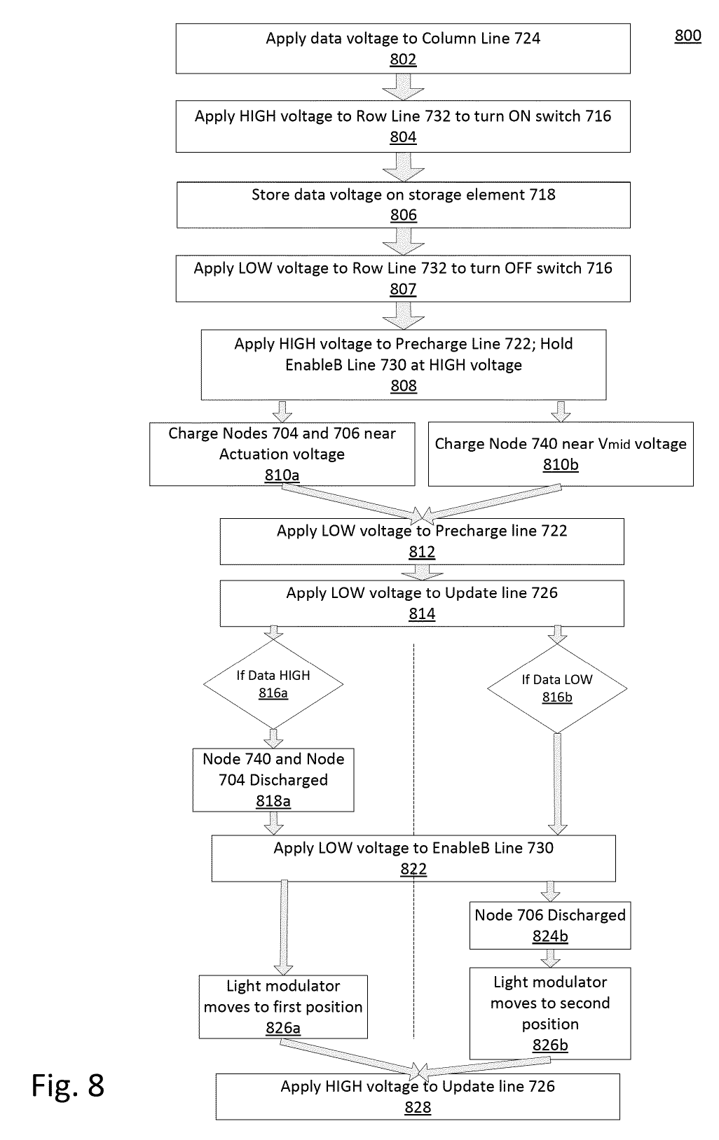

FIG. 8 is a block diagram of a method 800 for operating the control circuit 700 of FIG. 7. In block 802, a data voltage is applied to column line 724. The data voltage may provide instructions for the position of the light modulator 702. For example, the data voltage may be a ‘HIGH’ voltage or a ‘LOW’ voltage. In certain implementations, the data voltage may be an intermediate voltage. In block 804, a HIGH voltage is applied to row line 732. Since the row line 732 is electrically connected to the gate of switch 716, applying a HIGH voltage to row line 732 will turn switch 716 ‘ON,’ allowing the data voltage from the column line 724 to pass through switch 716. In block 806, the data voltage is stored on storage element 718. In certain implementations, the storage element may include a capacitor. After the data voltage is stored on storage element 718, a low voltage is applied to row line 732 to turn OFF switch 716 in block 807. Applying and storing a data voltage, as done in blocks 802-806, is described in more detail with respect to FIGS. 1A and 1B, above.

In block 808, a HIGH voltage is applied to the Precharge line 722, thus turning ON switches 710, 708 and 736. Turning ON switches 710, 708 and 736 allows the first node 704 and the second node 706 to be charged to approximately an actuation voltage level in block 810a, and for node A 740 to be charged to approximately V_{mid} voltage in block 810b. For example, in certain implementations, the actuation voltage level may be about 15-35 volts. In certain implementations, the V_{mid} voltage level may be about 5-20 volts. Also, in block 808, update line 726 and enableB line 730 are held at HIGH voltages. Holding update line 726 and enableB line 730 at HIGH voltages allows charge buildup of first node 704, second node 706 and node 740 during the charging process of blocks 810a and 810b, and prevents direct conduction from the actuate line 720 and the V_{mid} line 734 to update line 726 and enableB line 730. Once the first node 704 and second node 706 are sufficiently charged (e.g., to an actuation voltage), and node A 740 is sufficiently charged (e.g., to V_{mid} voltage), a LOW voltage is applied to the precharge line 722 in block 812 to turn off switches 710, 708 and 736. Next, in block 814, the update line 726 is brought to a LOW voltage.

If the data voltage stored on memory element 718 is HIGH (block 816a), switches 712 and 738 will be turned ON and the first node 704 and node A 740 will be discharged in block 818a. Because node A 740 has a lower capacitance than the first node 704, node A 740 will discharge faster than the first node 704, thereby preventing discharge of the second node 706 through switch 714 at the same time as discharge of the first node 704. After node A 740 is discharged, the enableB line 730 is brought to a LOW voltage in block 822. Because node A 740 discharges faster than the first node 704, the enableB line 730 can be brought to a LOW voltage faster than in control circuitry 500 of FIG. 5 where the first node 504 must be discharged fully before the enableB line 530 can be brought to a LOW voltage. This allows the control circuitry 700 of FIG. 7 to be operated approximately 50% faster than the control circuitry 500 of FIG. 5. Furthermore, connecting the gate of discharge switch 714 to node A 740 instead of to the first node 704 prevents charge injection on the first node 704 through discharge switch 714, and maintains a high enough voltage on the first node 704 to cause actuation of the light modulator 702. The prevention of charge injection through the discharge switch 714 may save power in the display device and prevents incorrect actuation of light modulator 702. After the enableB line 730 is brought to a LOW voltage in block 822, the first node 704 maintains a LOW voltage and the second node 706 maintains a HIGH (or near actuation) voltage. Accordingly, a LOW voltage is applied across electrode 740 connected to first node 704, and a HIGH voltage is applied across electrode 742 connected to the second node 706. If the shutter line 728 applies a LOW voltage to the light modulator 702, an electrostatic force will be created between the light modulator 702 and the electrode 742, and the light modulator moves to a first position in block 826a. In certain implementations, the first position of the light modulator may be an ‘open’ position where the light modulator allows light to pass through an aperture. In other implementations, the first position of the light modulator may be a ‘closed’ position where the light modulator blocks light from passing though an aperture. For example, in a shutter polarity inversion scheme, the light modulator may move into the opposite position when the data is HIGH as a scheme where shutter polarity inversion is not used.

If the data voltage stored on storage element 718 is LOW (block 816b), then switches 712 and 738 remain OFF and the first node 704 and node A 740 do not discharge their accumulated charges. Switch 714 is turned ON (after enableB line 730 is brought LOW) because node A 740 maintains a HIGH voltage (at approximately V_{mid}). In block 822, the enableB line 730 is brought to a LOW voltage the second node 706 is discharged. Accordingly, a LOW voltage is applied across electrode 742 connected to second node 706, and a HIGH voltage is applied across electrode 740 connected to the first node 704. If the shutter line 728 applies a LOW voltage to the light modulator 702, an electrostatic force will be created between the light modulator 702 and the electrode 740, and the light modulator moves to a second position in block 826b. In certain implementations, the second position of the light modulator may be an ‘open’ position where the light modulator allows light to pass through an aperture. In other implementations, the second position of the light modulator may be a ‘closed’ position where the light modulator blocks light from passing though an aperture. For example, in a shutter polarity inversion scheme, the light modulator may move into the opposite position when the data is LOW as a scheme where shutter polarity inversion is not used. After the light modulator moves (in blocks 826a or 826b), a HIGH voltage is applied to the update line 726 in step 828. The method 800 may begin again and repeat in accordance with the next set of light modulator movement instructions.

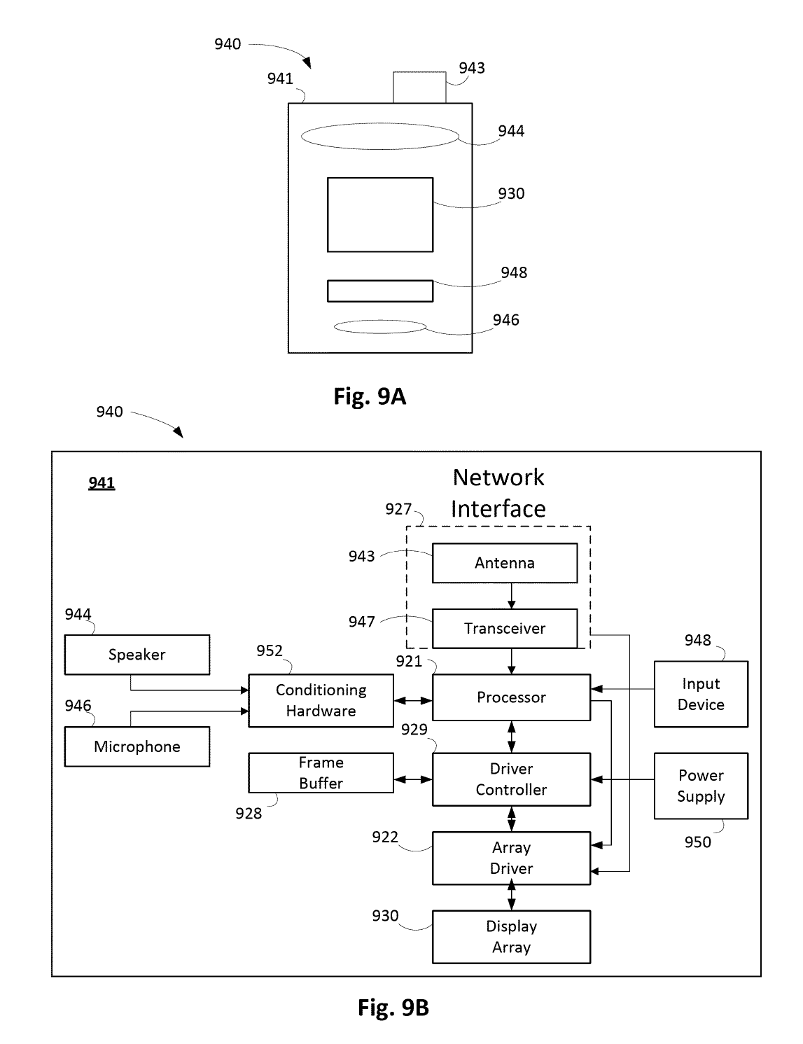

FIGS. 9A and 9B are system block diagrams illustrating a display device 940 that includes a plurality of MEMS light modulator display elements. The display device 940 can be, for example, a smart phone, a cellular or mobile telephone. However, the same components of the display device 940 or slight variations thereof are also illustrative of various types of display devices such as televisions, computers, tablets, e-readers, hand-held devices and portable media devices.

The display device 940 includes a housing 941, a display 930, an antenna 943, a speaker 944, an input device 948 and a microphone 946. The housing 941 can be formed from any of a variety of manufacturing processes, including injection molding, and vacuum forming. In addition, the housing 941 may be made from any of a variety of materials, including, but not limited to: plastic, metal, glass, rubber and ceramic, or a combination thereof. The housing 941 can include removable portions (not shown) that may be interchanged with other removable portions of different color, or containing different logos, pictures, or symbols.

The display 930 may be any of a variety of displays, including a bi-stable or analog display, as described herein. The display 930 also can be configured to include a flat-panel display, such as plasma, EL, OLED, STN LCD, or TFT LCD, or a non-flat-panel display, such as a CRT or other tube device. In addition, the display 930 can include a digital MEMS shutter (DMS) based display, as described herein.

The components of the display device 940 are schematically illustrated in FIG. 9B. The display device 940 includes a housing 941 and can include additional components at least partially enclosed therein. For example, the display device 940 includes a network interface 927 that includes an antenna 943 which can be coupled to a transceiver 947. The network interface 927 may be a source for image data that could be displayed on the display device 940. Accordingly, the network interface 927 is one example of an image source module, but the processor 921 and the input device 948 also may serve as an image source module. The transceiver 947 is connected to a processor 921, which is connected to conditioning hardware 952. The conditioning hardware 952 may be configured to condition a signal (such as filter or otherwise manipulate a signal). The conditioning hardware 952 can be connected to a speaker 944 and a microphone 946. The processor 921 also can be connected to an input device 948 and a driver controller 929. The driver controller 929 can be coupled to a frame buffer 928, and to an array driver 922, which in turn can be coupled to a display array 930. One or more elements in the display device 940, including elements not specifically depicted in FIG. 9A, can be configured to function as a memory device and be configured to communicate with the processor 921. In some implementations, a power supply 950 can provide power to substantially all components in the particular display device 940 design.

The network interface 927 includes the antenna 943 and the transceiver 947 so that the display device 940 can communicate with one or more devices over a network. The network interface 927 also may have some processing capabilities to relieve, for example, data processing requirements of the processor 921. The antenna 943 can transmit and receive signals. In some implementations, the antenna 943 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 943 transmits and receives RF signals according to the Bluetooth® standard. In the case of a cellular telephone, the antenna 943 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 947 can pre-process the signals received from the antenna 943 so that they may be received by and further manipulated by the processor 921. The transceiver 947 also can process signals received from the processor 921 so that they may be transmitted from the display device 940 via the antenna 943.

In some implementations, the transceiver 947 can be replaced by a receiver. In addition, in some implementations, the network interface 927 can be replaced by an image source, which can store or generate image data to be sent to the processor 921. The processor 921 can control the overall operation of the display device 940. The processor 921 receives data, such as compressed image data from the network interface 927 or an image source, and processes the data into raw image data or into a format that can be readily processed into raw image data. The processor 921 can send the processed data to the driver controller 929 or to the frame buffer 928 for storage. Raw data typically refers to the information that identifies the image characteristics at each location within an image. For example, such image characteristics can include color, saturation and gray-scale level.

The processor 921 can include a microcontroller, CPU, or logic unit to control operation of the display device 940. The conditioning hardware 952 may include amplifiers and filters for transmitting signals to the speaker 944, and for receiving signals from the microphone 946. The conditioning hardware 952 may be discrete components within the display device 940, or may be incorporated within the processor 921 or other components.

The driver controller 929 can take the raw image data generated by the processor 921 either directly from the processor 921 or from the frame buffer 928 and can re-format the raw image data appropriately for high speed transmission to the array driver 922. In some implementations, the driver controller 929 can re-format the raw image data into a data flow having a raster-like format, such that it has a time order suitable for scanning across the display array 930. Then the driver controller 929 sends the formatted information to the array driver 922. Although a driver controller 929, such as an LCD controller, is often associated with the system processor 921 as a stand-alone Integrated Circuit (IC), such controllers may be implemented in many ways. For example, controllers may be embedded in the processor 921 as hardware, embedded in the processor 921 as software, or fully integrated in hardware with the array driver 922.

The array driver 922 can receive the formatted information from the driver controller 929 and can re-format the video data into a parallel set of waveforms that are applied many times per second to the hundreds, and sometimes thousands (or more), of leads coming from the display's x-y matrix of display elements.

In some implementations, the driver controller 929, the array driver 922, and the display array 930 are appropriate for any of the types of displays described herein. For example, the driver controller 929 can be a conventional display controller or a bi-stable display controller (such as an IMOD display element controller). Additionally, the array driver 922 can be a conventional driver or a bi-stable display driver (such as an IMOD display element driver). Moreover, the display array 930 can be a conventional display array or a bi-stable display array (such as a display including an array of IMOD display elements). In some implementations, the driver controller 929 can be integrated with the array driver 922. Such an implementation can be useful in highly integrated systems, for example, mobile phones, portable-electronic devices, watches or small-area displays.

In some implementations, the input device 948 can be configured to allow, for example, a user to control the operation of the display device 940. The input device 948 can include a keypad, such as a QWERTY keyboard or a telephone keypad, a button, a switch, a rocker, a touch-sensitive screen, a touch-sensitive screen integrated with the display array 930, or a pressure- or heat-sensitive membrane. The microphone 946 can be configured as an input device for the display device 940. In some implementations, voice commands through the microphone 946 can be used for controlling operations of the display device 940.

The power supply 950 can include a variety of energy storage devices. For example, the power supply 950 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 950 also can be a renewable energy source, a capacitor, or a solar cell, including a plastic solar cell or solar-cell paint. The power supply 950 also can be configured to receive power from a wall outlet.

In some implementations, control programmability resides in the driver controller 929 which can be located in several places in the electronic display system. In some other implementations, control programmability resides in the array driver 922. The above-described optimization may be implemented in any number of hardware and/or software components and in various configurations.

As used herein, a phrase referring to “at least one of a list of” items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., a DMS display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical device, comprising:
an array of pixels including, for each respective pixel, at least one light modulator coupled between a first node and a second node, and
control circuitry including, for the respective pixel,
a first switch coupled to the first node for discharging an accumulated charge from the first node,
a second switch coupled to the second node for discharging an accumulated charge from the second node, and
a third switch coupled to the first switch, the second switch and a third node, the third switch capable of discharging an accumulated charge from the third node, wherein a gate of the third switch is coupled to a gate of the first switch.

2. The electromechanical device of claim 1, wherein a gate of the second switch is coupled to a source of the third switch.

3. The electromechanical device of claim 2, wherein the control circuitry further comprises:
a row line for enabling the pixel to respond to a data voltage,
a column line for providing the data voltage to a first storage element, and
an actuate line for providing an actuation voltage sufficient to actuate at least one light modulator.

4. The electromechanical device of claim 3, wherein the control circuitry further comprises:
a V_{mid} line for providing a V_{mid} voltage to the third node, wherein the V_{mid} voltage is less than or equal to the actuation voltage.

5. The electromechanical device of claim 4, wherein the control circuitry further comprises:
a pre-charge line for controlling application of the actuation voltage to the first and second nodes, and for controlling application of the V_{mid} voltage to the third node.

6. The electromechanical device of claim 5, wherein the control circuitry further comprises:
a fourth switch coupled to the actuate line, the pre-charge line and the first node, for controlling application of the actuation voltage to the first node,
a fifth switch coupled to the actuate line, the pre-charge line and the second node, for controlling application of the actuation voltage to the second node, and
a sixth switch coupled to the V_{mid} line, the pre-charge line and the third node, for controlling application of the V_{mid} voltage to the third node.

7. The electromechanical device of claim 6, wherein at least one of the first, second, third, fourth, fifth and sixth switches includes a transistor.

8. The electromechanical device of claim 3, wherein the first storage element is coupled to the gate of the first switch.

9. The electromechanical device of claim 3, wherein the control circuitry further comprises a second storage element coupled between the third node and a shutter line.

10. The electromechanical device of claim 9, wherein at least one of the first and second storage elements includes a capacitor.

11. The electromechanical device of claim 1, further comprising:
a first electrostatic actuator coupled to the first node, and
a second electrostatic actuator coupled to the second node, wherein the at least one light modulator is coupled between the first electrostatic actuator and the second electrostatic actuator, and the first and second electrostatic actuators are configured for moving the light modulator between a first position and a second position.

12. The electromechanical device of claim 11, further comprising, for each pixel at least one aperture, wherein the light modulator allows light to pass through the aperture in the first position, and blocks light from passing through the aperture in the second position.

13. The electromechanical device of claim 12, wherein the light modulator includes a MEMS-based shutter.

14. The electromechanical device of claim 1, further comprising:
a display;
a processor that is configured to communicate with the display, the processor being configured to process image data; and
a memory device that is configured to communicate with the processor.

15. The electromechanical device of claim 14, further comprising:
a driver circuit configured to send at least one signal to the display; and
a controller configured to send at least a portion of the image data to the driver circuit.

16. The electromechanical device of claim 14, further comprising:
an image source module configured to send the image data to the processor, wherein the image source module comprises at least one of a receiver, transceiver, and transmitter.

17. The electromechanical device of claim 14, further comprising:
an input device configured to receive input data and to communicate the input data to the processor.

18. A method for addressing an array of pixels in a display wherein a given pixel includes a light modulator coupled between first and second nodes, comprising:
storing a data voltage on a first storage element,
applying a high voltage to a pre-charge line,
applying the high voltage to an update line and an enableB line,
charging the first node and the second node to an actuate voltage,
charging a third node to a V_{mid} voltage,
applying a low voltage to the update line,
applying the low voltage to the enableB line, and
moving the light modulator to a first position based at least in part on the data voltage.

19. The method of claim 18, further comprising discharging an accumulated charge from the first node and third node, wherein the third node discharges the accumulated charge faster than the first node.

20. The method of claim 19, wherein the low voltage is applied to the enableB line after the third node is discharged.

21. The method of claim 18, wherein the array of pixels is addressed faster by applying a low voltage to the enableB line sooner.

22. An electromechanical device, comprising:
an array of pixels including, for each respective pixel, light modulating means coupled between a first node and a second node, and
control circuitry including, for the respective pixel, means for preventing charge injection at the first node.

23. The electromechanical device of claim 22, wherein the control circuitry includes, for the respective pixel, means for preventing simultaneous discharge of the first node and the second node.

24. The electromechanical device of claim 22, wherein the means for preventing charge injection at the first node prevents charge injection from an enableB line.
